(19) United States
(12) Patent Application Publication
(10) Pub. No.: US 2012/0257702 A1
(43) Pub. Date: Oct. 11, 2012

(54) ORDER OF DEBLOCKING

(76) Inventors: Matthias NARROSCHKE, Langen (DE); Hisao Sasai, Osaka (JP)

(21) Appl. No.: 13/083,932

(22) Filed: Apr. 11, 2011

(51) Int. Cl. H04N 7/64; H04N 7/26

(52) U.S. Cl. 375/E07.027; 375/E07.2; 375/E07.279

(57) ABSTRACT

The present invention relates to block-based video coding, in particular to methods for removing blocking artifacts in reconstructed video images. In conventional block-based video coding, both decoding and deblocking are performed on a block-by-block basis, which results in a plurality of dependencies between the various steps and processes. According to the present invention, deblocking is performed in batch mode after an entire frame has been decoded. Moreover, vertical and horizontal deblocking are separated in the sense that deblocking in the one direction is only performed after deblocking in the other direction is completed for the entire frame. In this manner, the decoding and deblocking processing can be split into a plurality of concurrent processes, which results in a highly efficient implementation both in hardware and in software.

### FIELD OF THE INVENTION

The present invention relates to block-based video coding, in particular to methods for removing blocking artifacts in reconstructed video images.

### BACKGROUND OF THE INVENTION

For the compression of video data, a plurality of video encoding standards has been developed. Such video standards are, for instance, ITU-T standards denoted with H.26x and ISO/IEC standards denoted with MPEG-x. The most up-to-date and advanced video encoding standard is currently the standard denoted as H.264/MPEG-4 AVC (Advanced Video Coding).

As a successor to H.264/MPEG-4 AVC, High Efficiency Video Coding (HEVC) is currently under joint development by the ISO/IEC Moving Picture Experts Group (MPEG) and ITU-T Video Coding Experts Group (VCEG). The new video standard HEVC will further improve coding efficiency as compared to AVC High Profile, i.e. reduce bitrate requirements by half with comparable image quality, probably at the expense of increased computational complexity. Depending on the application requirements, HEVC will be able to trade off computational complexity, compression rate, robustness to errors and processing delay time.

Both H.264/MPEG-4 AVC and HEVC are based on hybrid video coding, which consists of the following main stages:

(a) Dividing each individual video frame into two-dimensional blocks of pixels in order to subject each video frame to data compression at a block level.

(b) Decorrelating spatiotemporal video information by applying a spatio-temporal prediction scheme to each block and by transforming the prediction error from the spatial domain into the frequency domain so as to obtain coefficients.

(c) Reducing the overall amount of data by quantizing the resulting coefficients.

(d) Compressing the remaining data by encoding the quantized coefficients and prediction parameters by means of an entropy coding algorithm.

Hence, state-of-the-art video standards employ a Differential Pulse Code Modulation (DPCM) approach which only transmits differences between blocks of an input video sequence and their predictions based on previously encoded blocks (“the locally decoded image”). One of the prediction schemes that may be employed by these video coding standards is motion compensated prediction. In this prediction scheme, at least one motion vector is determined for each block of video data in order to describe image displacements caused be object and/or camera movements. Based on the motion vectors determined, the image content of one block may be predicted at least to a certain extend from the image content of previously coded blocks. The difference between the predicted and the actual input image content is called the prediction error, which is then encoded together with the motion vectors rather than the actual input image content. In this manner, a substantial reduction in the amount of information to be coded can be achieved for most “natural” video sequences.

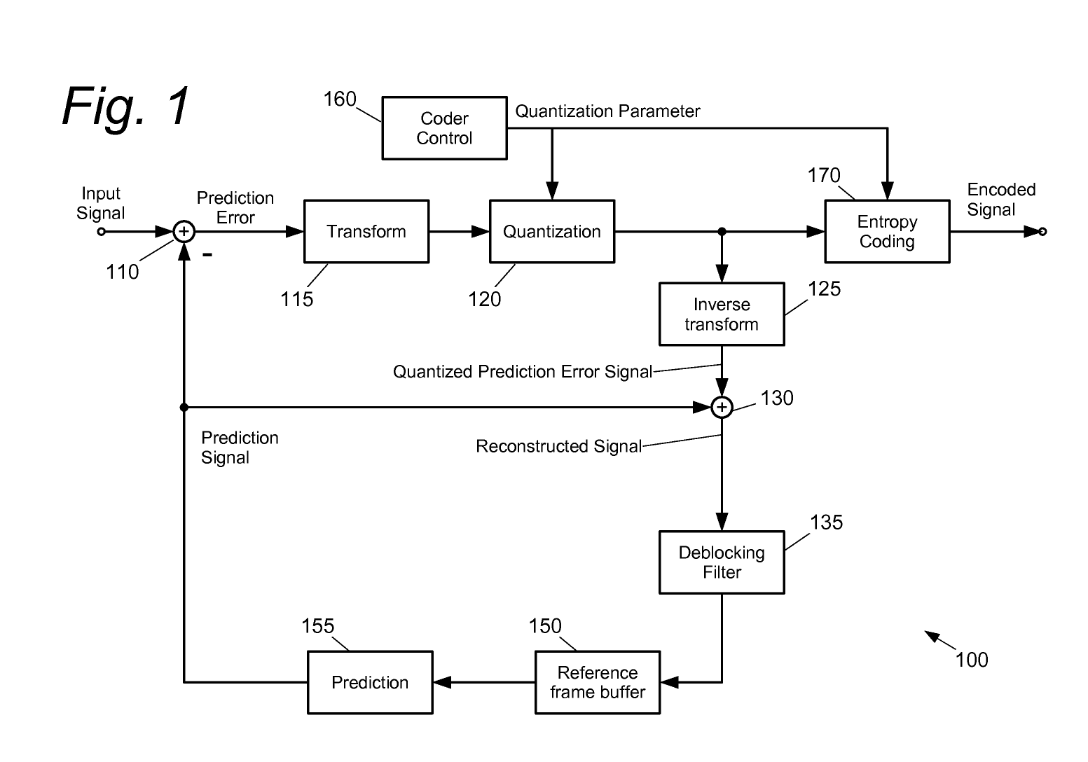

FIG. 1 is an exemplary block diagram of a conventional video encoder, which is in accordance with the emerging High Efficiency Video coding (HEVC) standard, as well as with the established H.264/AVC standard. The video encoder, generally denoted by reference numeral 100, comprises a subtractor 110 for determining differences between a current block of a video image (input signal) and a prediction signal of the current block which is based on previously encoded blocks (“the locally decoded image”) stored in the reference frame memory 150. The reference frame memory 150 thus operates as a delay unit that allows a comparison between current signal values and a prediction signal generated by prediction unit 155 from previous signal values. A transform unit 115 and a quantization unit 120 transforms the resulting prediction error from the spatial domain to the frequency domain and quantizes the obtained coefficients in accordance with a quantization parameter provided by controller 160. An entropy coding unit 170 entropy encodes the quantized coefficients and the quantization parameter.

The locally decoded image is provided by a decoding unit incorporated into video encoder 100. The decoding unit performs the encoding steps in reverse manner. An inverse transform unit 125 applies an inverse transformation to the quantized coefficients. In adder 130, the decoded differences are added to the prediction signal to form the locally decoded image.

Due to the quantization, quantization noise is superposed to the reconstructed video signal. Due to the blockwise coding, the superposed noise often has a blocking characteristic, which may be subjectively annoying. In order to reduce the blocking characteristic, a deblocking filter 135 is applied to the reconstructed signal, which is the sum of the prediction signal and the quantized prediction error signal.

The deblocked signal is the decoded signal, which is generally displayed. The deblocking filter in H.264/AVC, as well as in HEVC, has the capability of local adaptation. In the case of a high degree of blocking noise, a strong low pass filter is applied whereas for a low degree of blocking noise, a weak low pass filter is applied. The strength of the low pass filter is determined by the prediction and by the quantized prediction error signal. This deblocking filter has the following two benefits:
1. Block edges are smoothed resulting in an improved subjective quality of decoded images.
2. Since the filtered macroblock is used for the motion-compensated prediction of further images, the filtering may result in smaller prediction errors and thus in improved coding efficiency.

As an example for deblocking at a vertical block boundary, a linear deblocking filter with four coefficients is provided. This filter is applied to input samples p₂, p₁, p₀, q₀, q₁ and q₂, wherein p₀ and q₀ are two adjacent pixels at the block boundary, p₁ and q₁ pixels adjacent to p₀ and q₀, and so on. The filter output p_{0,new} and q_{0,new} is then defined as P_{0,new}=(p₂−(p₁<<1)+(p₀+q₀+1)>>1)>>1 and q_{0,new}=(q₂−(q₁<<1)+(q₀+p₀+1)>>1)>>1. Further details on the conventional deblocking filter process can be found in the document “WD3: Working Draft 3 of High-Efficiency Video Coding” by Thomas Wiegand, Woo-Jin Han, Benjamin Bross, Jens-Rainer Ohm, and Gary J. Sullivan (JCTVC-E603, Joint Collaborative Team on Video Coding (JCT-VC) of ITU-T SG16 WP3 and ISO/IEC JTC1/SC29/WG11, Geneva, CH, 16-23 Mar., 2011), which is incorporated herewith in its entirety.

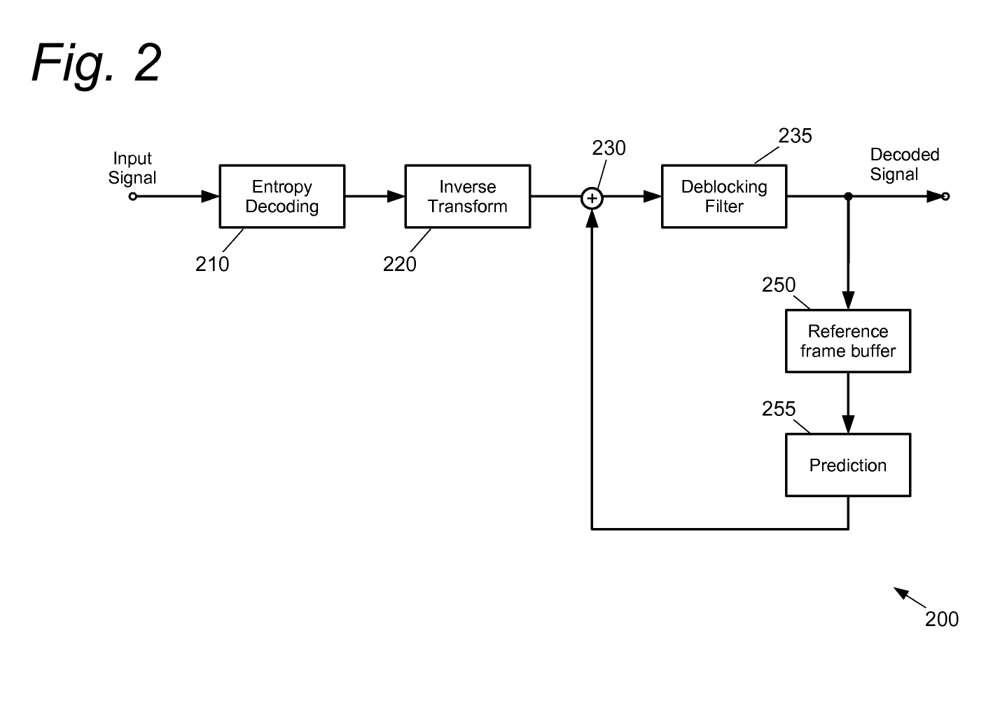

For reconstructing the encoded images at the decoder side, the encoding process is applied in reverse manner. A schematic block diagram, illustrating the configuration of the corresponding decoder, is shown in FIG. 2.

In decoder 200 of FIG. 2, first the entropy encoding of coefficients is reversed in an entropy decoding unit 210. The decoded block of quantized coefficients is then submitted to an inverse transform unit 220. The result of the inverse transform is the quantized prediction error in the spatial domain, which is added by adder 230 to the prediction signal stemming from the prediction unit 255. The reconstructed image is passed through a deblocking filter 235 and the resulting decoded signal is stored in reference frame buffer 250 to be provided to prediction unit 255.

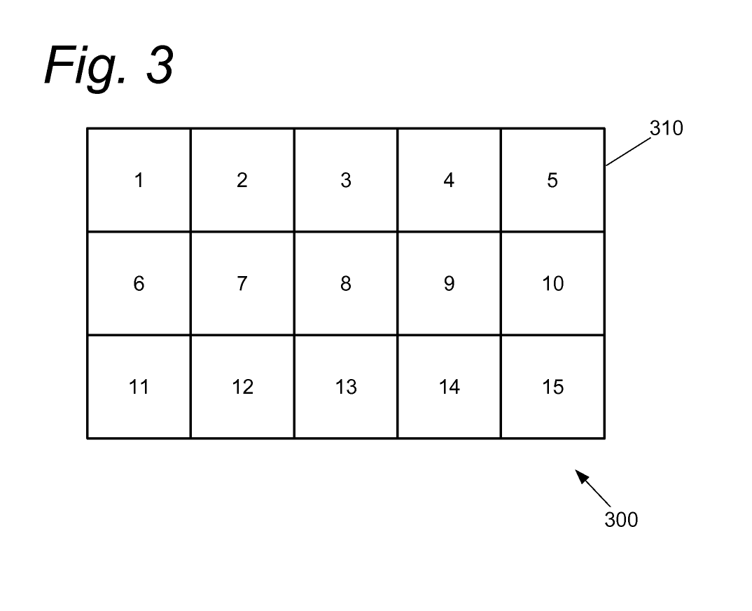

FIG. 3 is a schematic illustration of a frame 300 of video data divided into a plurality of blocks 310 denoted as largest coding units (LCUs) according to HEVC. The numbers indicate the processing order of the LCUs: According to HEVC, the individual LCUs of a frame of video data are processed line-by-line, starting with the top-most LCU to the left.

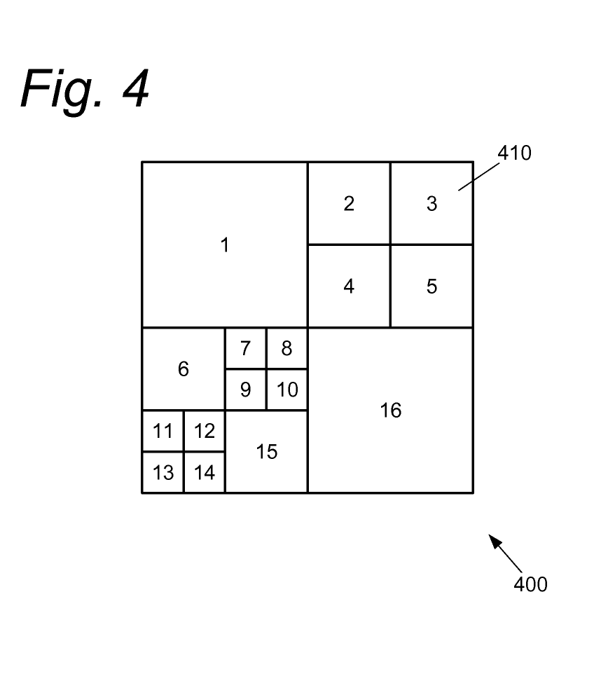

The size of an LCU may vary, for example, from 8×8 pixels to 64×64 pixels. Each LCU may be further divided into independently encoded sub-blocks denoted as coding units (CUs). An example of an LCU 400 divided into 16 distinct CUs 410 is shown in FIG. 4. The numbers indicate the order in which the individual CUs 410 are encoded and decoded (Z-scan).

Each of the individual CUs may be encoded with a different quantization parameter, different prediction method, and different prediction parameters. This may lead to disturbing blocking artifacts at the edges of the CUs. These artifacts are reduced by applying a deblocking filter at each of the various horizontal and vertical edges, as explained above.

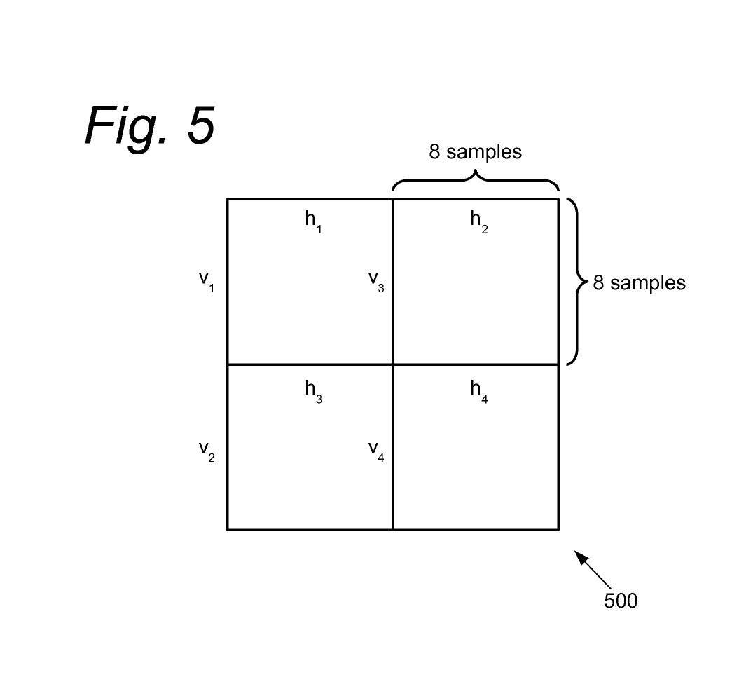

This is further illustrated in FIG. 5, which shows an exemplary 16×16CU. A CU with 16×16 pixels may be further subdivided into 4 blocks of 8×8 pixels each, which may be coded by different coding parameters. This leads to a total of four vertical edges v₁, v₂, v₃, v₄ and four horizontal edges h₁, h₂, h₃, h₄, which are considered during deblocking for each 16×16 CU. The smallest block size considered during deblocking is 8×8, i.e., edges of less than 8 pixels length are neglected.

Specifically, the following deblocking steps are performed in the stated order:
1. For all vertical edges v, of current CU: decide whether edge vᵢ has to be filtered or not
2. If so, apply vertical deblocking filter to edge vᵢ
3. For all horizontal edges of current CU: decide whether edge hᵢ has to be filtered or not
4. If so, apply horizontal deblocking filter to edge hᵢ

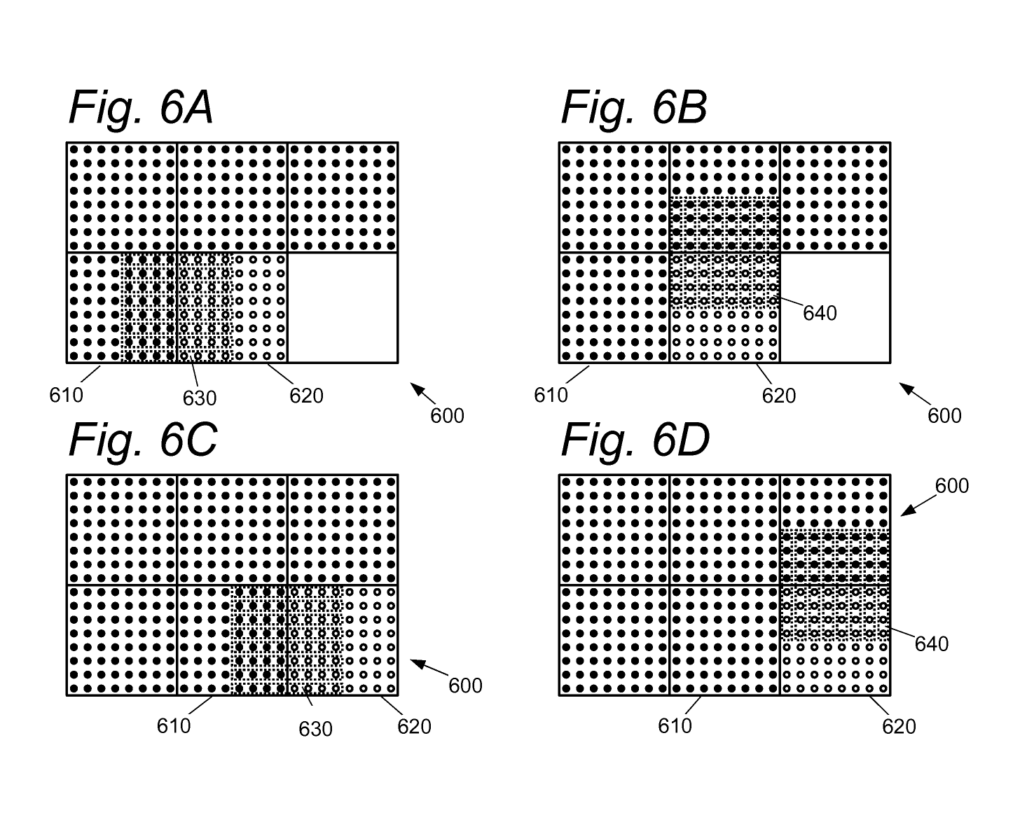

The sequence of steps performed during conventional (de-)coding and deblocking is illustrated in FIGS. 6A to 6D. Each of FIGS. 6A-6D shows (part of) a frame 600 of video data consisting of six exemplary CUs 610, 620 of 8×8 pixels each. Previously decoded pixels are indicated by filled circles, pixels that are currently decoded are indicated by open circles.

In the first step illustrated in FIG. 6A, the left vertical edge of a current CU 620 is subjected to deblocking by applying a horizontal deblocking filter to each set 630 of eight horizontally arranged pixels, as indicated by the broken lines. In the second step illustrated in FIG. 6B, the upper edge of the current CU 620 is subjected to deblocking by applying a vertical deblocking filter to each set 640 of eight vertically arranged pixels, as indicated by the broken lines.

These steps are repeated when the next CU is decoded. In FIG. 6C, the left vertical edge of the current CU 620 is subjected to deblocking by applying a horizontal deblocking filter to each set 630 of eight horizontally arranged pixels, as indicated by the broken lines. Subsequently, the upper edge of the current CU 620 is subjected to deblocking by applying a vertical deblocking filter to each set 640 of eight vertically arranged pixels, as illustrated by broken lines in FIG. 6D.

In this manner, all edges of all coding units will be subjected to deblocking filtering as decoding progresses.

The problem with this approach, however, is that there are many dependencies between the individual steps that impede an efficient implementation both in hardware and in software. For instance, deblocking of a vertical edge can only be performed if the previous CU, i.e., the block to the left of the edge, has already been decoded; the next CU, on the other hand, can only be decoded when deblocking of the current block is completed. Moreover, deblocking of a horizontal edge can only be performed after deblocking of nearby vertical edges has been completed since there are always pixels in the corners of a coding unit that are affected by both horizontal and vertical deblocking.

### SUMMARY OF THE INVENTION

Therefore, it is an object of the present invention to provide an improved deblocking method that allows for a more efficient hardware and software implementation. Specifically, it is an object of the present invention to provide a deblocking method that lends itself to parallel processing.

This is achieved by the features as set forth in the independent claims.

Preferred embodiments are the subject matter of dependent claims.

It is the particular approach of the present invention to perform deblocking filtering of all horizontal edges of a given frame in a first step and to perform deblocking filtering of all vertical edges of said frame in a second step, or vice versa. In this manner, the application of the individual horizontal or vertical deblocking filters in the first or the second step can be performed independently of each other. This allows for a more efficient implementation, both in software that is adapted for state-of-the-art multicore processors and in hardware with multiple processing pipelines.

According to a first aspect of the present invention, a method for deblocking video data is provided. The method comprises the steps of receiving a frame of video data consisting of a plurality of blocks, each block consisting of a plurality of pixels; applying a horizontal deblocking filter to each vertical edge between two horizontally adjacent blocks of video data; and applying a vertical deblocking filter to each horizontal edge between two vertically adjacent blocks of video data, wherein either the horizontal deblocking filter is applied to all vertical edges before the vertical deblocking filter is applied to a horizontal edge, or the vertical deblocking filter is applied to all horizontal edges before the horizontal deblocking filter is applied to a vertical edge.

Preferably, a size of the blocks and a support (i.e., the set of pixels that are taken into account for the filtering) of the vertical deblocking filter are adapted such that each pixel of the plurality of blocks is affected by at most one application of the vertical deblocking filter, so that the steps of applying the vertical deblocking filter are independent of each other. Further, a size of the blocks and a support of the horizontal deblocking filter are preferably adapted such that each pixel of the plurality of blocks is affected by at most one application of the horizontal deblocking filter, so that the steps of applying the horizontal deblocking filter are independent of each other. In this manner, the application of deblocking filters on different edges do not affect each other and the corresponding processes may be performed parallel to each other.

Specifically, the steps of applying the vertical and/or the horizontal deblocking filter are performed parallel to each other, which results in a reduction of overall processing time.

According to a second aspect of the present invention, a method for decoding video data is provided. The method comprises the steps of receiving compressed video data comprising prediction error data; for each block of a frame of video data, predicting said block from previously decoded video data; reconstructing the frame of video data by adding the prediction error data to the predicted blocks; and deblocking the reconstructed frame of video data with a method according to the first aspect of the present invention.

According to a third aspect of the present invention, a method for encoding video data is provided. The method comprises the steps of receiving video data; predicting video data from previously encoded video data; computing prediction error data indicating a difference between the received video data and the predicted video data; and encoding the prediction error data, wherein the predicting step further comprises the step of generating locally decoded video data by decoding the previously encoded video data with a method according to the second aspect of the present invention.

According to a fourth aspect of the present invention, a video decoder for decoding compressed video data comprising prediction error data is provided. The video decoder comprises a prediction unit configured for predicting video data from previously decoded video data; an adder for obtaining reconstructed video data by adding the prediction error data to the predicted video data; a buffer memory for storing a frame of reconstructed video data consisting of a plurality of blocks, each block consisting of a plurality of pixels; a first filter unit configured for applying a horizontal deblocking filter to each vertical edge between two horizontally adjacent blocks of video data; and a second filter unit configured for applying a vertical deblocking filter to each horizontal edge between two vertically adjacent blocks of video data; wherein either the horizontal deblocking filter is applied to all vertical edges before the vertical deblocking filter is applied to a horizontal edge, or the vertical deblocking filter is applied to all horizontal edges before the horizontal deblocking filter is applied to a vertical edge.

Finally, according to a fifth aspect of the present invention, a video encoder for encoding input video data is provided. The video data encoder comprises a predicting unit configured for predicting video data from previously encoded video data; a computing unit configured for computing prediction error data indicating a difference between the input video data and the predicted video data; an encoding unit configured for encoding the prediction error data, wherein the predicting unit further comprises a video decoder according to the fourth aspect of the present invention for generating locally decoded video data by decoding the previously encoded video data.

The above and other objects and features of the present invention will become more apparent from the following description and preferred embodiments given in conjunction with the accompanying drawings, in which:

FIG. 1 is an exemplary block diagram of a conventional video encoder;

FIG. 2 is an exemplary block diagram of a conventional video decoder;

FIG. 3 is an illustration of the conventional processing order in a frame with a plurality of LCUs;

FIG. 4 is an illustration of the conventional processing order in an LCU with a plurality of CUs;

FIG. 5 is an illustration of the edges within a CU that are considered during deblocking;

FIGS. 6A-6D is an illustration of the steps performed during decoding and deblocking according to a conventional method;

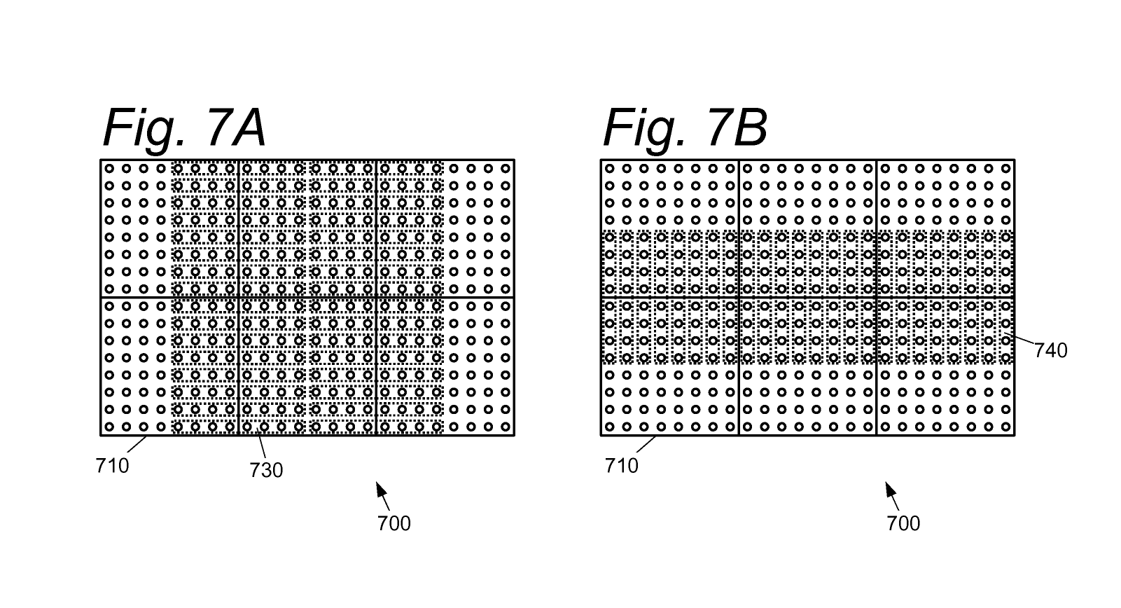

FIGS. 7A-7B is an illustration of the steps performed during decoding and deblocking according to the present invention;

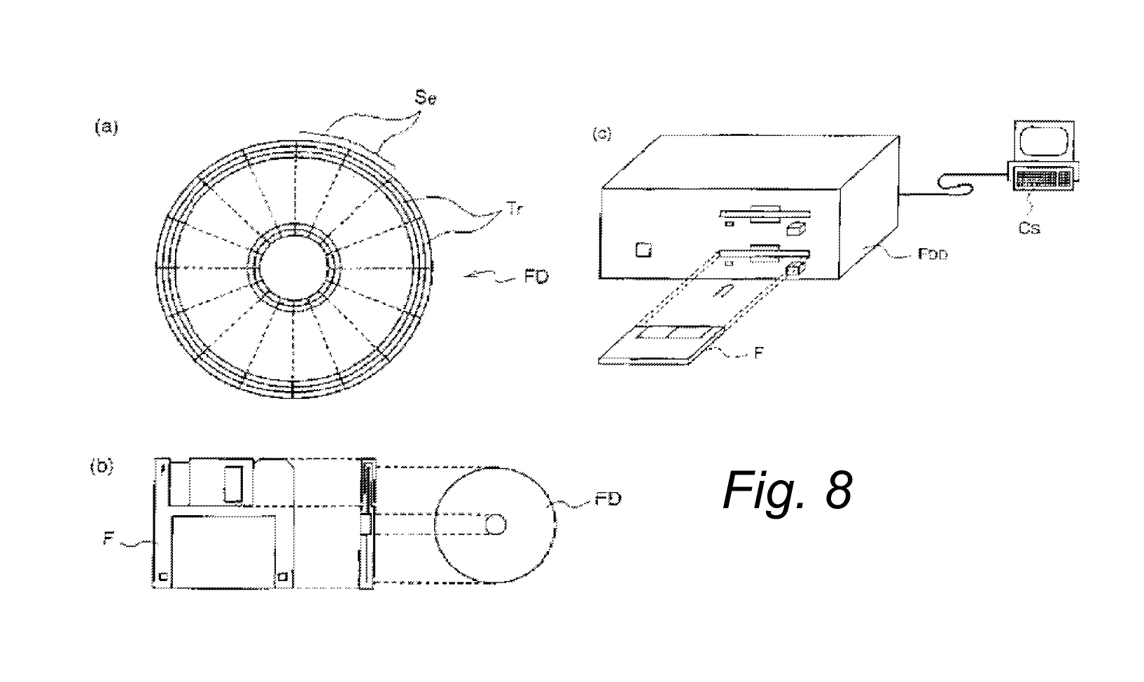

FIG. 8 is an illustration of a recording medium for storing a program realizing any of the embodiments of the present invention by means of a computer system;

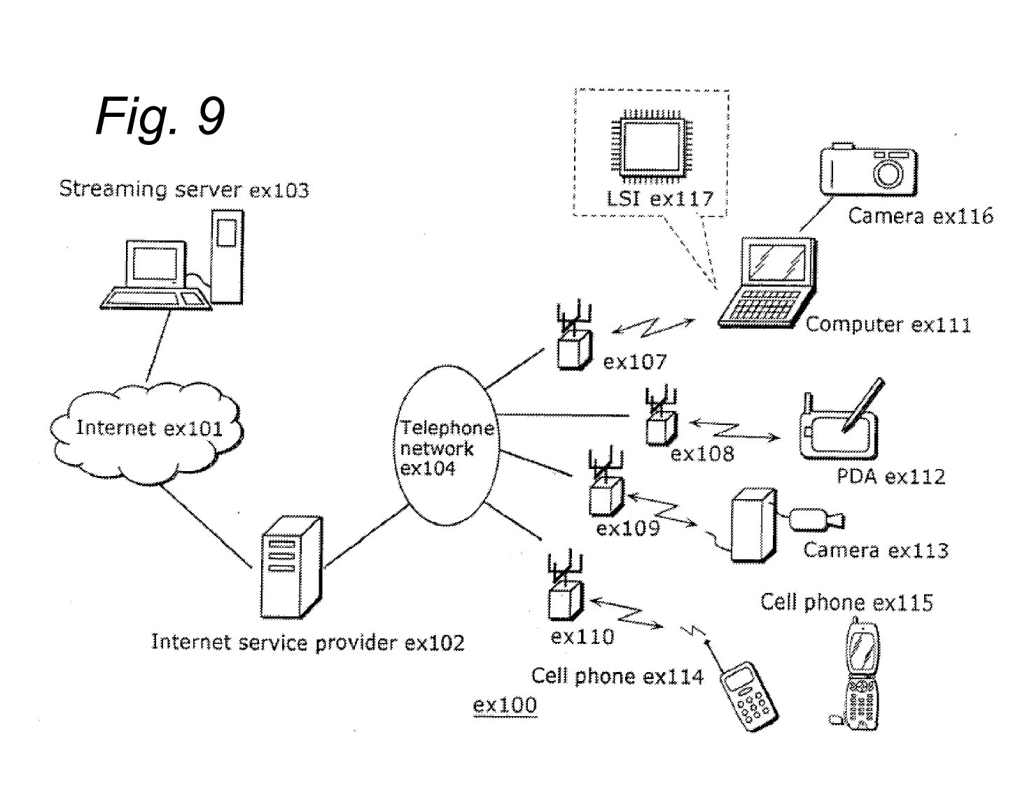

FIG. 9 is a block diagram showing an overall configuration of a content supply system for realizing a content distribution service using the coding and decoding approach of the present invention;

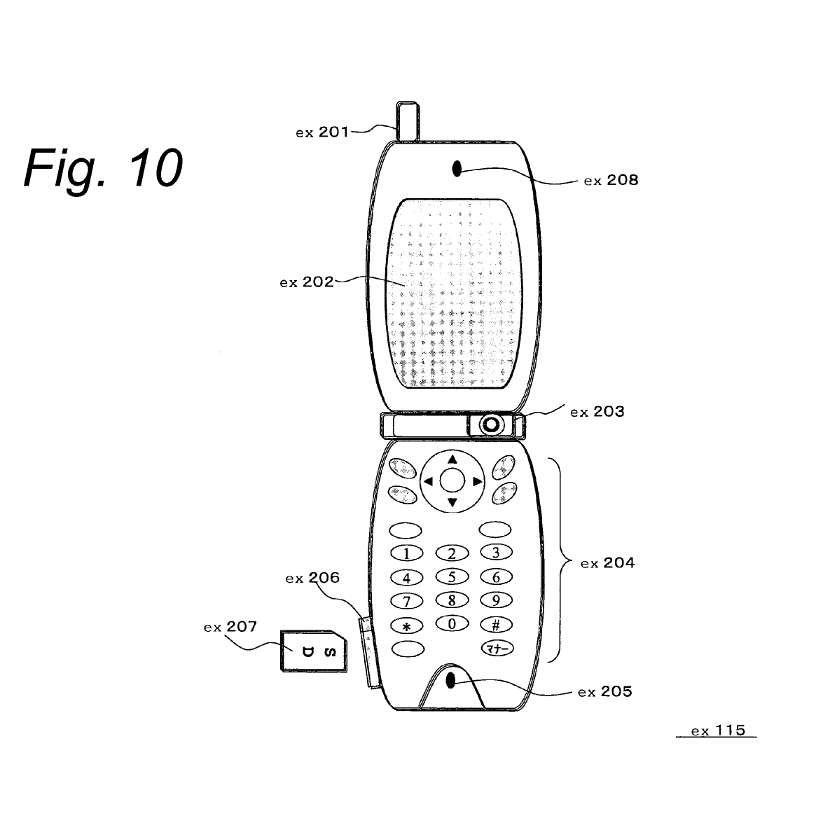

FIG. 10 is a schematic drawing showing a cell phone for using the video/audio coding approach of the present invention;

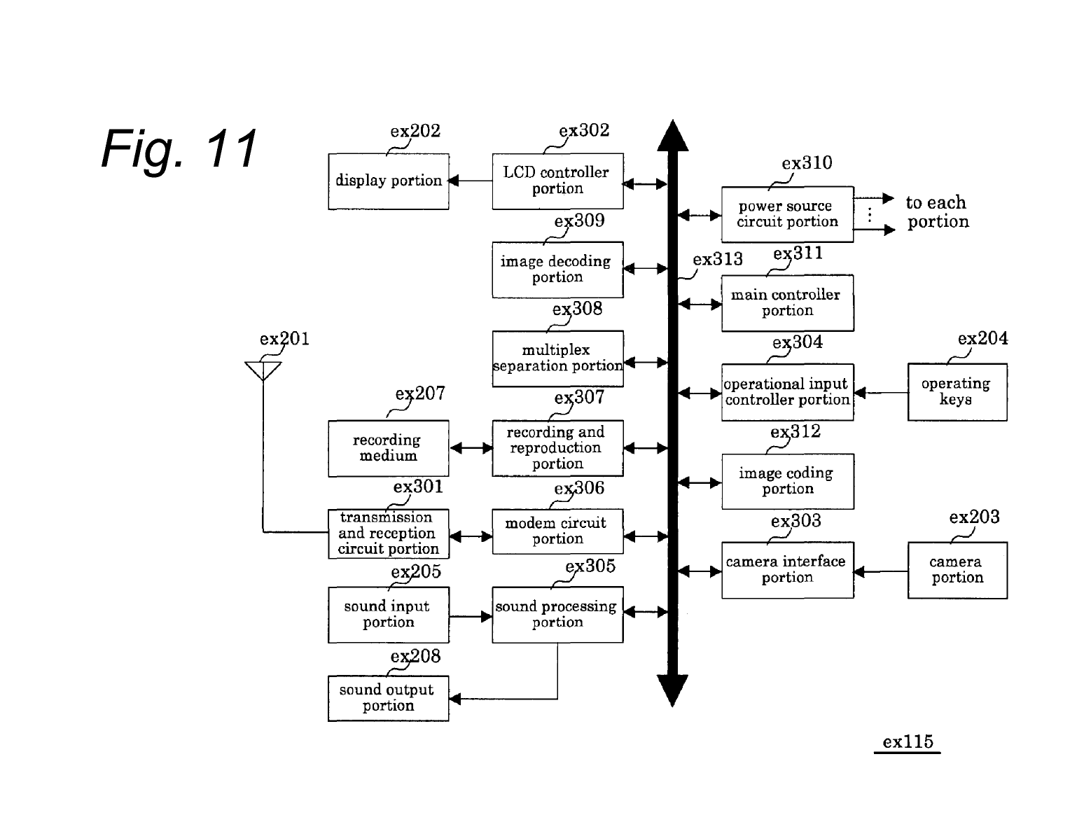

FIG. 11 is a block diagram illustrating the functional blocks of the cell phone exemplified in FIG. 10; and

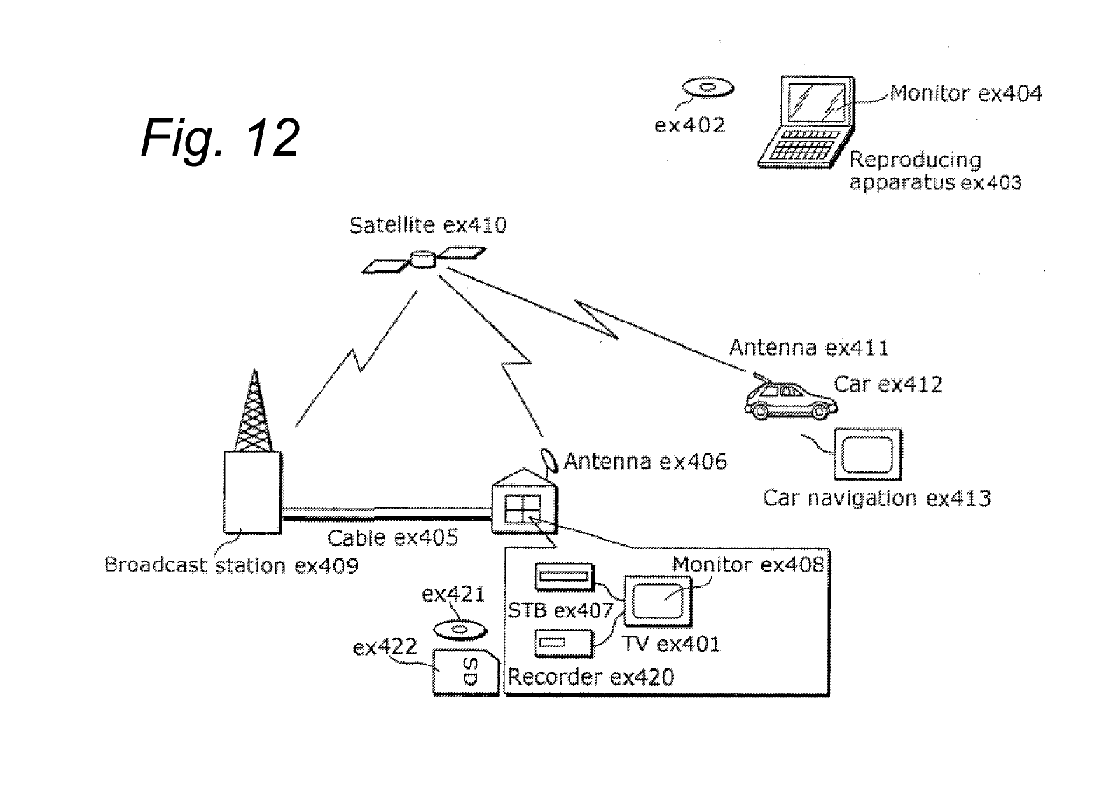

FIG. 12 is illustrating a wireless digital system for incorporating the coding and decoding approach of the present invention.

### DETAILED DESCRIPTION OF THE PREFERRED EMBODIMENTS

According to the present invention, deblocking is no longer performed on a block-by-block basis but in batch mode for an entire frame. Moreover, the processes of decoding, horizontal deblocking, and vertical deblocking are disentangled in the sense that, in a first step, a plurality of blocks is decoded, which are then simultaneously subjected to horizontal deblocking in a second step. After horizontal deblocking is completed, all blocks are subjected to vertical deblocking in a third step. Obviously, the sequence of the horizontal deblocking and the vertical deblocking may be exchanged.

In this manner, the dependencies between the individual steps are substantially reduced, allowing for highly efficient implementation on concurrent computing systems.

FIG. 7A schematically illustrates a frame 700 of video data, consisting of a plurality of coding units 710 with 8×8 pixels each. In a first step, pixel data has been decoded for each of said coding units (open circles). In a second step, all vertical edges within the plurality of coding units are subjected to horizontal deblocking. The support (i.e., the set of pixels that are taken into account for the filtering) of the horizontal deblocking filter, which is illustrated by a broken line in FIG. 7A, comprises eight pixels arranged on a horizontal line, namely four pixels to the left of the edge and four pixels to the right of the edge. As it is apparent from FIG. 7A, the support of the deblocking filter does not overlap when applied to different edges. Therefore, application of the deblocking filter to one edge does not interfere with the application of the deblocking filter to another edge. Consequently, the step of performing deblocking of vertical edges can be split into up to N concurrent processes, wherein N is the number of vertical edges times the length of these edges in pixels (4 edges times 8 pixels=32 concurrent processes in the example shown).

FIG. 7B is an illustration similar to that of FIG. 7A and illustrates the application of vertical deblocking filters to the horizontal edges of the frame. Again, the support of the various filters do not overlap, so that the individual deblocking filters can be applied independently of each other. Specifically, the step of performing deblocking of horizontal edges can be split into up to N concurrent processes, wherein N is the number of horizontal edges times the length of these edges in pixels (3 edges times 8 pixels=24 concurrent processes in the example shown).

Obviously, the sequence of performing horizontal and vertical deblocking is not relevant for the present invention. In fact, the vertical edges may also be deblocked after the vertical edges have been deblocked, or vice versa.

Further, the deblocking process may be applied independently to each of the three color components, which results in a further increase in the number of concurrent processes.

The frame size and the number of coding units illustrated in FIGS. 7A and 7B is by way of example only and the present invention may be applied to any number of coding units, blocks, or macro-blocks. Moreover, the present invention may also be applied to coding units, blocks, or macro-blocks of various sizes, including mixtures of coding units, blocks, or macro-blocks of different sizes, as illustrated in FIG. 4. The size of a coding unit, a block, or a macro-block may including 8 by 8 pixels, 16 by 16 pixels, 32 by 32 pixels, and 64 by 64 pixels. Other sizes are possible.

In the context of video coding and decoding, it is particularly beneficial to apply the present invention on a frame-by-frame basis, i.e., to decode all coding units, blocks, or macro-blocks of a given frame, store the decoded coding units, blocks, or macro-blocks in a frame buffer, and apply horizontal and vertical deblocking to the entire frame in batch mode.

According to a preferred embodiment of the present invention, the inventive deblocking method is employed in a block-based video decoder, in particular in a video decoder for decoding video data compressed in accordance with the H.264/MPEG-4 ACV standard or the emerging HEVC standard. Needless to say that a highly efficient implementation of the decoding and deblocking processes by means of parallelization and concurrent processing is particularly important in the context of high-definition (HD) video footage.

According to another preferred embodiment of the present invention, the inventive deblocking method is employed in a block-based video encoder, in particular in a video encoder for encoding video data according to the H.264/MPEG-4 ACV standard or the emerging HEVC standard.

To summarize, the present invention relates to block-based video coding, in particular to methods for removing blocking artifacts in reconstructed video images. In conventional block-based video coding, both decoding and deblocking are performed on a block-by-block basis, which results in a plurality of dependencies between the various steps and processes. According to the present invention, deblocking is performed in batch mode after an entire frame has been decoded. Moreover, vertical and horizontal deblocking are separated in the sense that deblocking in the one direction is only performed after deblocking in the other direction is completed for the entire frame. In this manner, the decoding and deblocking processing can be split into a plurality of concurrent processes, which results in a highly efficient implementation both in hardware and in software.

The various embodiments of the invention may either be implemented by means of software modules, which are executed by a processor, or directly in hardware. Also a combination of software modules and a hardware implementation is possible. The software modules may be stored on any kind of computer readable storage media, for example RAM, EPROM, EEPROM, flash memory, registers, hard disks, CD-ROM, DVD, etc.

The present invention may in particular be embodied in form of a computer program product comprising a computer readable medium having a computer readable program code embodied thereon, the program code being adapted to carry out a method according to any of the appended claims. However, the present invention may also be embodied as an apparatus for data compression or decompression, in particular as an apparatus for video and/or audio data encoding or decoding, comprising a plurality of functional units, each of which being adapted for performing one step of a method according to any of the appended claims.

According to a further embodiment, it is possible to easily perform the processing shown in the above embodiments in an independent computing system by recording a program for realizing the coding and decoding methods shown in the above-mentioned embodiments onto the storage medium such as a flexible disk.

FIG. 8 is an illustration of a recording medium for storing a program for realizing any of the described embodiments by a computer system.

FIG. 8, part (b) shows a full appearance of a flexible disk, its structure at cross section and the flexible disk itself whereas FIG. 8, part (a) shows an example of a physical format of the flexible disk as a main body of a storing medium. A flexible disk FD is contained in a case F, a plurality of tracks Tr are formed concentrically from the periphery to the inside on the surface of the disk, and each track is divided into 16 sectors Se in the angular direction. Therefore, as for the flexible disk storing the above-mentioned program, data as the aforementioned program is stored in an area assigned for it on the flexible disk FD.

FIG. 8, part (c) shows a structure for recording and reading out the program on the flexible disk FD. When the program is recorded on the flexible disk FD, the computing system Cs writes in data as the program via a flexible disk drive. When the coding device and the decoding device are constructed in the computing system by the program on the flexible disk, the video/audio coding method and a video/audio decoding method as the program is read out from the flexible disk drive and then transferred to the computing system Cs.

The above explanation is made on an assumption that a storing medium is a flexible disk, however, the same processing can also be performed using an optical disk. In addition, the storing medium is not limited to a flexible disk and an optical disk, but any other medium such as an IC card and a ROM cassette capable of recording a program can be used.

According to still another embodiment, the following is an explanation of the applications of the video/audio coding method as well as the video/audio decoding method as shown in the above-mentioned embodiments, and a system using them.

FIG. 9 is a block diagram showing an overall configuration of a content supply system ex100 for realizing content distribution service. The area for providing communication service is divided into cells of desired size, and cell sites ex107 to ex110, which are fixed wireless stations are placed in respective cells.

This content supply system ex100 is connected to devices such as Internet ex101, an Internet service provider ex102, a telephone network ex104, as well as a computer ex111, a PDA (Personal Digital Assistant) ex112, a camera ex113, a cell phone ex114 and a cell phone with a camera ex115 via the cell sites ex107 to ex110.

However, the content supply system ex100 is not limited to the configuration as shown in FIG. 9 and may be connected to a combination of any of them. Also, each device may be connected directly to the telephone network ex104, not through the cell sites ex107 to ex110.

The camera ex113 is a device capable of shooting video such as a digital video camera. The cell phone ex114 may be a cell phone of any of the following system: a PDC (Personal Digital Communications) system, a CDMA (Code Division Multiple Access) system, a W-CDMA (Wideband-Code Division Multiple Access) system or a GSM (Global System for Mobile Communications) system, a PHS (Personal Handyphone System) or the like.

A streaming server ex103 is connected to the camera ex113 via the telephone network ex104 and also the cell site ex109, which realizes a live distribution or the like using the camera ex113 based on the coded data transmitted from the user. Either the camera ex113 or the server which transmits the data may code the data. Also, the image/video data shot by a camera ex116 may be transmitted to the streaming server ex103 via the computer ex111. In this case, either the camera ex116 or the computer ex111 may code the image/video data. An LSI ex117 included in the computer ex111 or the camera ex116 actually performs coding processing. Software for video and/or audio coding and decoding may be integrated into any type of storage medium (such as a CD-ROM, a flexible disk and a hard disk) that is a recording medium which is readable by the computer ex111 or the like. Furthermore, a cell phone with a camera ex115 may transmit the image/video data. This image/video data is the data coded by the LSI included in the cell phone ex115.

The content supply system ex100 codes contents (such as a music live video) shot by a user using the camera ex113, the camera ex116 or the like in the same way as shown in the above-mentioned embodiments and transmits them to the streaming server ex103, while the streaming server ex103 makes stream distribution of the content data to the clients at their requests.

The clients include the computer ex111, the PDA ex112, the camera ex113, the cell phone ex114 and so on capable of decoding the above-mentioned coded data. In the content supply system ex100, the clients can thus receive and reproduce the coded data, and can further receive, decode and reproduce the data in real time so as to realize personal broadcasting.

When each device in this system performs coding or decoding, the data compression and decompression methods of the above-mentioned embodiments can be used.

A cell phone will be explained as an example of the device.

FIG. 10 is a diagram showing the cell phone ex115 using the data compression and decompression methods explained in the above-mentioned embodiments. The cell phone ex115 has an antenna ex201 for communicating with the cell site ex110 via radio waves, a camera unit ex203 such as a CCD camera capable of shooting moving and still pictures, a display unit ex202 such as a liquid crystal display for displaying the data such as decoded pictures and the like shot by the camera unit ex203 or received by the antenna ex201, a body unit including a set of operation keys ex204, a audio output unit ex208 such as a speaker for outputting audio, a audio input unit ex205 such as a microphone for inputting audio, a storage medium ex207 for storing coded or decoded data such as data of moving or still pictures shot by the camera, data of received e-mails and that of moving or still pictures, and a slot unit ex206 for attaching the storage medium ex207 to the cell phone ex115. The storage medium ex207 stores in itself a flash memory element, a kind of EEPROM (Electrically Erasable and Programmable Read Only Memory) that is a nonvolatile memory electrically erasable from and rewritable to a plastic case such as an SD card.

Next, the cell phone ex115 will be explained with reference to FIG. 11. In the cell phone ex115, a main control unit ex311, designed in order to control overall each unit of the main body which contains the display unit ex202 as well as the operation keys ex204, is connected mutually to a power supply circuit unit ex310, an operation input control unit ex304, a picture coding unit ex312, a camera interface unit ex303, an LCD (Liquid Crystal Display) control unit ex302, a picture decoding unit ex309, a multiplexing/demultiplexing unit ex308, a read/write unit ex307, a modem circuit unit ex306 and a audio processing unit ex305 via a synchronous bus ex313.

When a call-end key or a power key is turned ON by a user's operation, the power supply circuit unit ex310 supplies respective units with power from a battery pack so as to activate the camera attached digital cell phone ex115 as a ready state.

In the cell phone ex115, the audio processing unit ex305 converts the audio signals received by the audio input unit ex205 in conversation mode into digital audio data under the control of the main control unit ex311 including a CPU, ROM and RAM, the modem circuit unit ex306 performs spread spectrum processing of the digital audio data, and the communication circuit unit ex301 performs digital-to-analog conversion and frequency conversion of the data, so as to transmit it via the antenna ex201. Also, in the cell phone ex115, the communication circuit unit ex301 amplifies the data received by the antenna ex201 in conversation mode and performs frequency conversion and analog-to-digital conversion to the data, the modem circuit unit ex306 performs inverse spread spectrum processing of the data, and the audio processing unit ex305 converts it into analog audio data, so as to output it via the audio output unit ex208.

Furthermore, when transmitting an e-mail in data communication mode, the text data of the e-mail inputted by operating the operation keys ex204 of the main body is sent out to the main control unit ex311 via the operation input control unit ex304. In the main control unit ex311, after the modem circuit unit ex306 performs spread spectrum processing of the text data and the communication circuit unit ex301 performs digital-to-analog conversion and frequency conversion for the text data, the data is transmitted to the cell site ex110 via the antenna ex201.

When picture (video) data is transmitted in data communication mode, the picture data shot by the camera unit ex203 is supplied to the picture coding unit ex312 via the camera interface unit ex303. When it is not transmitted, it is also possible to display the picture data shot by the camera unit ex203 directly on the display unit ex202 via the camera interface unit ex303 and the LCD control unit ex302.

The picture coding unit ex312, which includes a picture coding apparatus as explained in the present invention, compresses and codes the picture data supplied from the camera unit ex203 by the coding method used for the picture coding apparatus as shown in the above-mentioned embodiment so as to transform it into coded picture data, and sends it out to the multiplexing/demultiplexing unit ex308. At this time, the cell phone ex115 sends out the audio received by the audio input unit ex205 during the shooting with the camera unit ex203 to the multiplexing/demultiplexing unit ex308 as digital audio data via the audio processing unit ex305.

The multiplexing/demultiplexing unit ex308 multiplexes the coded picture data supplied from the picture coding unit ex312 and the audio data supplied from the audio processing unit ex305 using a predetermined method, then the modem circuit unit ex306 performs spread spectrum processing of the multiplexed data obtained as a result of the multiplexing, and lastly the communication circuit unit ex301 performs digital-to-analog conversion and frequency conversion of the data for the transmission via the antenna ex201.

As for receiving data of a moving picture file which is linked to a Web page or the like in data communication mode, the modem circuit unit ex306 performs inverse spread spectrum processing of the data received from the cell site ex110 via the antenna ex201, and sends out the multiplexed data obtained as a result of the inverse spread spectrum processing.

In order to decode the multiplexed data received via the antenna ex201, the multiplexing/demultiplexing unit ex308 separates the multiplexed data into a bit stream of picture data and that of audio data, and supplies the coded picture data to the picture decoding unit ex309 and the audio data to the audio processing unit ex305 respectively via the synchronous bus ex313.

Next, the picture decoding unit ex309, including a picture decoding apparatus as explained in the present invention, decodes the bit stream of picture data using the decoding method corresponding to the coding method as shown in the above-mentioned embodiments to generate reproduced moving picture data, and supplies this data to the display unit ex202 via the LCD control unit ex302, and thus the picture data included in the moving picture file linked to a Web page, for instance, is displayed.

At the same time, the audio processing unit ex305 converts the audio data into analog audio data, and supplies this data to the audio output unit ex208, and thus the audio data included in the moving picture file linked to a Web page, for instance, is reproduced.

The present invention is not limited to the above-mentioned system as such ground-based or satellite digital broadcasting has been in the news lately and at least either the picture coding apparatus or the picture decoding apparatus described in the above-mentioned embodiments can be incorporated into a digital broadcasting system as shown in FIG. 12. More specifically, a bit stream of video information is transmitted from a broadcast station ex409 to or communicated with a broadcast satellite ex410 via radio waves.

Upon receipt of it, the broadcast satellite ex410 transmits radio waves for broadcasting. Then, a home-use antenna ex406 with a satellite broadcast reception function receives the radio waves, and a television (receiver) ex401 or a set top box (STB) ex407 decodes the bit stream for reproduction. The picture decoding apparatus as shown in the above-mentioned embodiment can be implemented in the reproducing apparatus ex403 for reading out and decoding the bit stream recorded on a storage medium ex402 that is a recording medium such as CD and DVD. In this case, the reproduced video signals are displayed on a monitor ex404. It is also conceivable to implement the picture decoding apparatus in the set top box ex407 connected to a cable ex405 for a cable television or the antenna ex406 for satellite and/or ground-based broadcasting so as to reproduce them on a monitor ex408 of the television ex401. The picture decoding apparatus may be incorporated into the television, not in the set top box. Also, a car ex412 having an antenna ex411 can receive signals from the satellite ex410 or the cell site ex107 for reproducing moving pictures on a display device such as a car navigation system ex413 set in the car ex412.

Furthermore, the picture coding apparatus as shown in the above-mentioned embodiments can code picture (video) signals and record them on a recording medium. As a concrete example, a recorder ex420 such as a DVD recorder for recording picture signals on a DVD disk ex421, a disk recorder for recording them on a hard disk can be cited. They can be recorded on an SD card ex422. If the recorder ex420 includes the picture decoding apparatus as shown in the above-mentioned embodiments, the picture signals recorded on the DVD disk ex421 or the SD card ex422 can be reproduced for display on the monitor ex408. As for the structure of the car navigation system ex413, the structure without the camera unit ex203, the camera interface unit ex303 and the picture coding unit ex312, out of the components shown in FIG. 11, is conceivable. The same applies for the computer ex111, the television (receiver) ex401 and others.

In addition, three types of implementations can be conceived for a terminal such as the above-mentioned cell phone ex114; a sending/receiving terminal implemented with both a coder and a decoder, a sending terminal implemented with a coder only, and a receiving terminal implemented with a decoder only. As described above, it is possible to use the methods described in the above-mentioned embodiments for any of the above-mentioned devices and systems, and by using this method, the effects described in the above-mentioned embodiments can be obtained.

Another embodiment of the invention relates to the implementation of the above described various embodiments using hardware and software. It is recognized that the various embodiments of the invention may be implemented or performed using computing devices (processors). A computing device or processor may for example be general-purpose processors, digital signal processors (DSP), application specific integrated circuits (ASIC), field programmable gate arrays (FPGA) or other programmable logic devices, etc. The various embodiments of the invention may also be performed or embodied by a combination of these devices.

Most of the examples have been outlined in relation to an H.264/AVC based video coding system or to an HEVC based video coding system, and the terminology mainly relates to the H.264/AVC and the HEVC terminology, respectively. However, this terminology and the description of the various embodiments is not intended to limit the principles and ideas of the invention. Also the detailed explanations of the encoding and decoding in compliance with the H.264/AVC standard are intended to better understand the exemplary embodiments described herein and should not be understood as limiting the invention to the described specific implementations of processes and functions in the video coding. Nevertheless, the improvements proposed herein may be readily applied in the video coding described. Furthermore, the concept of the invention may be also readily used in the enhancements of H.264/AVC coding and the emerging HEVC standard currently discussed by the Joint Video Team (JVT).

1. A method for deblocking video data, comprising the steps of
receiving a frame of video data consisting of a plurality of blocks, each block consisting of a plurality of pixels;
applying a horizontal deblocking filter to each vertical edge between two horizontally adjacent blocks of video data; and
applying a vertical deblocking filter to each horizontal edge between two vertically adjacent blocks of video data,
wherein either the horizontal deblocking filter is applied to all vertical edges before the vertical deblocking filter is applied to a horizontal edge, or the vertical deblocking filter is applied to all horizontal edges before the horizontal deblocking filter is applied to a vertical edge.

2. A method for deblocking video data according to claim 1, wherein a size of the blocks and a support of the vertical deblocking filter are adapted such that each pixel of the plurality of blocks is affected by at most one application of the vertical deblocking filter, so that the steps of applying the vertical deblocking filter are independent of each other.

3. A method for deblocking video data according to claim 1, wherein the steps of applying the vertical deblocking filter are performed parallel to each other.

4. A method for deblocking video data according to claim 1, wherein a size of the blocks and a support of the horizontal deblocking filter are adapted such that each pixel of the plurality of blocks is affected by at most one application of the horizontal deblocking filter, so that the steps of applying the horizontal deblocking filter are independent of each other.

5. A method for deblocking video data according to claim 1, wherein the steps of applying the horizontal deblocking filter are performed parallel to each other.

6. A method for deblocking video data according to claim 1,
wherein the plurality of blocks comprises a first block, a second block, a third block, and a fourth block, the first and the second block being vertically adjacent to the third and the fourth block, respectively, and the first and the third block being horizontally adjacent to the second and the fourth block, respectively;
wherein the steps of applying the horizontal deblocking filter comprises a first filtering step of applying a horizontal deblocking filter to a vertical edge between the first and the second block and a second filtering step of applying the horizontal deblocking filter to a vertical edge between the third and the fourth block;
wherein the steps of applying the vertical deblocking filter comprises a third filtering step of applying a vertical deblocking filter to a horizontal edge between the first and the third block and a fourth filtering step of applying the vertical deblocking filter to a horizontal edge between the second and the fourth block;
wherein both the first and the second filtering step are performed prior to or after the third and the fourth filtering step.

7. A method for deblocking video data according to claim 6, wherein the first and the second filtering step are performed parallel to each other.

8. A method for deblocking video data according to claim 6, wherein the third and the fourth filtering step are performed parallel to each other.

9. A method for deblocking video data according to claim 1, wherein the plurality of blocks comprises at least two blocks of different size, including 8 by 8 pixels, 16 by 16 pixels, 32 by 32 pixels, and 64 by 64 pixels.

10. A method for decoding video data, said method comprising the steps of
receiving compressed video data comprising prediction error data;
for each block of a frame of video data, predicting said block from previously decoded video data;
reconstructing the frame of video data by adding the prediction error data to the predicted blocks; and
deblocking the reconstructed frame of video data with a method according to claim 1.

11. A method for encoding video data, said method comprising the steps of
receiving video data;
predicting video data from previously encoded video data;
computing prediction error data indicating a difference between the received video data and the predicted video data; and
encoding the prediction error data,
wherein the predicting step further comprises the step of generating locally decoded video data by decoding the previously encoded video data with a method according to claim 10.

12. A video decoder for decoding compressed video data comprising prediction error data, the video decoder comprising:
a prediction unit configured for predicting video data from previously decoded video data;
an adder for obtaining reconstructed video data by adding the prediction error data to the predicted video data;
a buffer memory for storing a frame of reconstructed video data consisting of a plurality of blocks, each block consisting of a plurality of pixels;
a first filter unit configured for applying a horizontal deblocking filter to each vertical edge between two horizontally adjacent blocks of video data; and
a second filter unit configured for applying a vertical deblocking filter to each horizontal edge between two vertically adjacent blocks of video data;
wherein either the horizontal deblocking filter is applied to all vertical edges before the vertical deblocking filter is applied to a horizontal edge, or the vertical deblocking filter is applied to all horizontal edges before the horizontal deblocking filter is applied to a vertical edge.

13. A video decoder according to claim 12, wherein the first filter unit is further configured for applying the horizontal deblocking filter to at least two of the vertical edges simultaneously.

14. A video decoder according to claim 12, wherein the second filter unit is further configured for applying the vertical deblocking filter to at least two of the horizontal edges simultaneously.

15. A video encoder for encoding input video data, said video encoder comprising:
a predicting unit configured for predicting video data from previously encoded video data;
a computing unit configured for computing prediction error data indicating a difference between the input video data and the predicted video data;
an encoding unit configured for encoding the prediction error data,
wherein the predicting unit further comprises a video decoder according to claim 12 for generating locally decoded video data by decoding the previously encoded video data.
